(19) United States
(12) Patent Application Publication
(10) Pub. No.: US 2016/0336586 A1
(43) Pub. Date: Nov. 17, 2016

(54) NEGATIVE ELECTRODE ACTIVE MATERIAL FOR NONAQUEOUS ELECTROLYTE SECONDARY BATTERIES

(71) Applicant: SANYO ELECTRIC CO., LTD., Osaka (JP)

(72) Inventors: Kouhei Tuduki, Hyogo (JP); Ayano Toyoda, Osaka (JP); Atsushi Fukui, Hyogo (JP); Taizou Sunano, Osaka (JP)

(73) Assignee: Sanyo Electric Co., Ltd., Daito-shi, Osaka (JP)

(21) Appl. No.: 15/112,793

(22) PCT Filed: Jan. 22, 2015
(86) PCT No.: PCT/JP2015/000273

§ 371 Date: Jul. 20, 2016

(30) Foreign Application Priority Data
Jan. 28, 2014 (JP) 2014-012962

(51) Int. Cl. H01M 4/134; H01M 4/62; H01M 4/38; H01M 10/0525; H01M 4/36

(52) U.S. Cl. CPC H01M 4/134; H01M 10/0525; H01M 4/366; H01M 4/386; H01M 4/62; H01M 2004/027

(57) ABSTRACT

Provided is a negative electrode active material, containing at least silicon, for nonaqueous electrolyte secondary batteries. Since the negative electrode active material contains silicon, the negative electrode active material has high capacity and excellent cycle characteristics. A negative electrode active material for nonaqueous electrolyte secondary batteries contains at least silicon. At least, one portion of the surface of each of primary particles containing silicon is covered with an inert phase made of a silicon compound with a silicon oxidation number higher than that of the silicon, a metal-silicon alloy, or metal. The primary particles containing silicon may form secondary particles. The silicon compound with a silicon oxidation number higher than that of silicon is preferably Li₂Si₂O₅, Li₂SiO₃, or Li₄SiO₄. Furthermore, the metal-silicon alloy is preferably FeSi and the metal is preferably Ti. Furthermore, the crystallite size of silicon is 500 Å or less.

### TECHNICAL FIELD

The present invention relates to negative electrode active materials for nonaqueous electrolyte secondary batteries and particularly relates to a negative electrode active material for nonaqueous electrolyte secondary batteries using a silicon-containing material as a negative electrode active material.

### BACKGROUND ART

In order to increase the energy density of lithium secondary batteries, a silicon-containing material which stores lithium by an alloying reaction with lithium and which therefore has high volumetric specific capacity is promising as a candidate for a novel negative electrode active material instead of graphite materials in practical use.

However, silicon has a problem that charge/discharge cycle characteristics are reduced because the change in volume of an active material during the storage and release of lithium is large and therefore the active material is pulverized.

Patent Literature 1 discloses that a coating containing an oxoacid salt (lithium silicate or the like) is formed on the surface of silicon for the purpose of enhancing cycle characteristics of a battery using a silicon-containing material as a negative electrode active material.

Patent Literature 2 discloses the use of nano-sized silicon alloy particles.

Patent Literature 3 discloses particles in which insulating and conducting phases are uniformly dispersed in a phase made of silicon.

However, it is difficult for techniques disclosed in Patent Literatures 1 to 3 to cope with market requirements for the capacity and charge/discharge cycle characteristics of nonaqueous electrolyte secondary batteries. The further increase of capacity and the enhancement of cycle characteristics are required.

### CITATION LIST

### Patent Literature

PTL 1: Japanese Published Unexamined Patent Application No. 2008-135382

PTL 2: Japanese Published Unexamined Patent Application No. 2011-32541

PTL 3: Japanese Published Unexamined Patent Application No. 2013-521620

### SUMMARY OF INVENTION

### Technical Problem

However, in the case where only a coating preventing a reaction with an electrolyte solution is formed on the surface as described in Preceding Technical Literature 1, the coating on the surface of silicon is broken due to the expansion and contraction of silicon during charge and discharge in accordance with the progress of cycles and therefore sufficient cycle characteristics cannot be obtained.

The nano-sizing of particles of silicon as described in Preceding Technical Literature 2 is known as a method for suppressing the expansion and contraction of silicon. It is known that reducing the size of silicon reduces the absolute expansion of the particles and provides the effect of hardening the particles because of a nano-size effect. However, the use of nano-sized particles leads to an increase in surface area to increase the contact area with an electrolyte solution; hence, the degradation reaction of the electrolyte solution during charge and discharge is significant. Therefore, there is a problem in that cycle characteristics cannot be enhanced.

It has been proposed that an active metal phase containing silicon, an insulating phase, and a conducting phase are hybridized for the purpose of preventing a reaction with an electrolyte solution as described in Patent Literature 3. However, Patent Literature 3 does not sufficiently describe a hybridization state during hybridization or a hybridization technique. Therefore, the possibility that the active phase and the insulating phase are independently present is high. The insulating phase does not serve as a path for ions or electrons. Therefore, in order to make paths for ions and electrons, a state that internal silicon is sufficiently hybridized and has a bond is necessary. In the case where no paths for ions and electrons are formed, heterogeneous reactions occur in particles and some of the particles expand significantly; hence, the particles are broken and cycle characteristics are adversely affected. When the insulating phase and silicon are independently present, the effect of preventing the contact of silicon with an electrolyte solution by covering the surface of silicon with the insulating phase is not created. Therefore, there is a problem in that cycle characteristics cannot be enhanced.

Accordingly, it is an object of the present invention to achieve high capacity by containing silicon and to provide a negative electrode active material for nonaqueous electrolyte secondary batteries with excellent cycle characteristics.

### Solution to Problem

A negative electrode active material for nonaqueous electrolyte secondary batteries contains at least silicon. At least one portion of the surface of each of primary particles containing silicon is covered with an inert phase made of a silicon compound with a silicon oxidation number higher than that of the silicon, a metal-silicon alloy, or metal.

Herein, the primary particles containing silicon may form secondary particles. The silicon compound with a silicon oxidation number higher than that of silicon is preferably Li₂Si₂O₅, Li₂SiO₃, or Li₄SiO₄. Furthermore, the metal-silicon alloy is preferably FeSi. The metal is preferably Ti. Furthermore, the grain size of silicon is 500 Å or less.

### Advantageous Effects of Invention

According to the present invention, at least one portion of the surface of each of primary particles containing silicon is provided with an inert phase made of a silicon compound with a silicon oxidation number higher than that of silicon, a metal-silicon alloy, or metal and therefore good initial charge/discharge characteristics and charge/discharge cycle characteristics can be enhanced.

### BRIEF DESCRIPTION OF DRAWINGS

FIG. 1 is a cross-sectional backscattered electron image of a negative electrode active material according to Example 1.

FIG. 2 is a schematic view of the negative electrode active material according to Example 1.

FIG. 3 is an X-ray diffraction pattern of the negative electrode active material according to Example 1.

FIG. 4 is a cross-sectional backscattered electron image of a negative electrode active material according to Example 2.

FIG. 5 is a schematic view of the negative electrode active material according to Example 2.

### DESCRIPTION OF EMBODIMENTS

The present invention is further described in detail with reference to examples. The present invention is not limited to the examples below. Appropriate modifications can be made without departing from the spirit of the present invention.

### Example 1

[Preparation of Negative Electrode Active Material]

First, a silicon ingot produced by a metallurgical process was crushed, whereby granular silicon with a particle size of 1 mm was prepared. Thereafter, 5 kg of the granular silicon with a particle size of 1 mm and stainless steel balls (20 mm, 30 mm) were charged into a 200 L stainless steel vessel. Next, the stainless steel vessel was subjected to a first mechanical milling treatment in a rotary bail mill so as to have a specific surface area of 10 m/g to 100 m/g as determined by a BET method.

Thereafter, 50 g of a mixture of the silicon subjected to the first mechanical milling treatment and a Li₂SiO₃ powder (the mixing ratio of Si to Li₂SiO₃ was 70:30 on a mol basis) and stainless steel bails (20 mm) were charged into a 500 ml stainless steel vessel and a second mechanical milling treatment was performed for 50 hours in a planetary bail mill. These powders were heat-treated at 600° C. for 4 hours in a 196 MPa inert atmosphere under high-pressure conditions. Thereafter, a sintered product was pulverized and classified in a jet mill such that the median diameter D50 was about 5μm, whereby a negative electrode active material a1 was obtained.

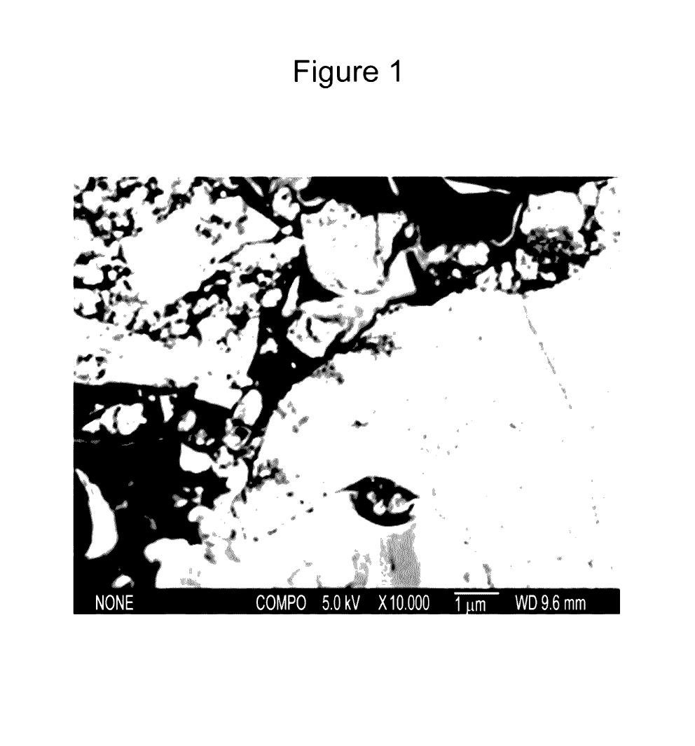

FIG. 1 shows a cross-sectional backscattered electron image of a powder of the negative electrode active material al. Referring to FIG. 1, there is little space between a high-contrast white portion (corresponding to an active phase made of silicon) and a low-contrast gray portion (corresponding to an inert phase made of Li₂SiO₃). In the present, invention, this state is defined as a secondary particle state. As is clear from the backscattered electron image, the periphery of silicon is covered with an inert phase made of Li₂SiO₃ and silicon and the inert phase are bonded to each other and are in the secondary particle state. The size of the inert phase is 100 nm or less as measured from the backscattered electron image. Finer particles have reduced expansion and the breakage of the particles can be suppressed; hence, the size of the active phase is 1 μm or less.

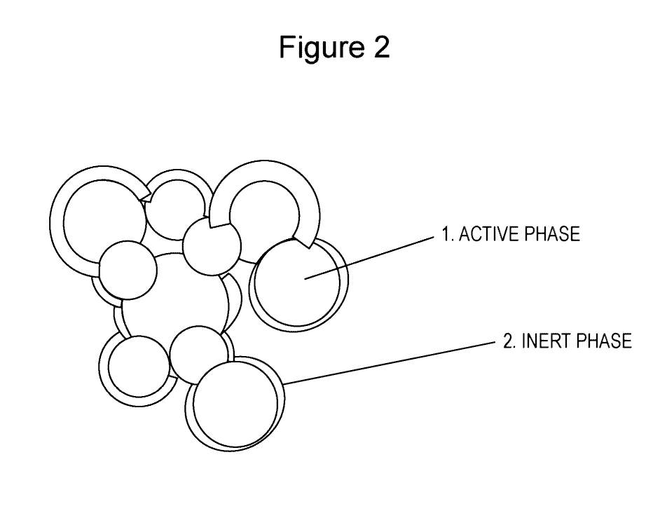

FIG. 2 shows a schematic view of the negative electrode active material al. FIG. 2 is a schematic view for easily understanding the structure of the negative electrode active material a1 that is inferred from the backscattered electron image in FIG. 1. In this figure, reference numeral 1 represents active phases made of silicon and reference numeral 2 represents inert phases made of, for example, Li₂SiO₃. The following state is shown: a state that the active phases 1 made of silicon form a secondary particle and the peripheries thereof are covered with the inert phases 2.

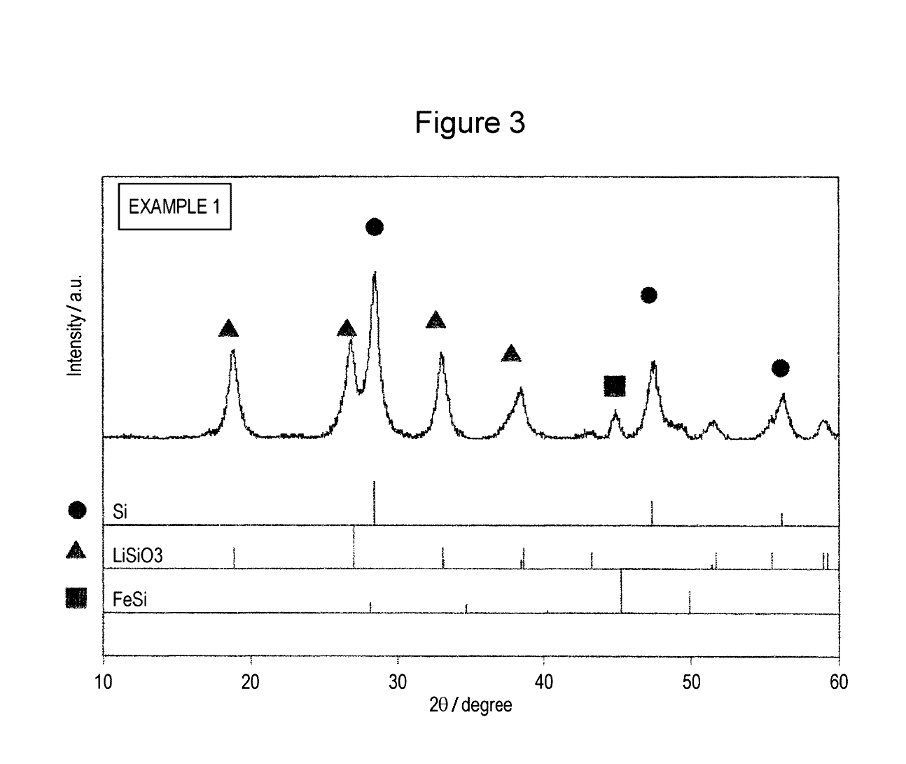

FIG. 3 shows an X-ray diffraction pattern of the negative electrode active material al. As is clear from FIG. 3, an Si phase, an Li₂SiO₃ phase, and an FeSi phase are present. The grain size Lc was 120 Å as determined from results of the X-ray diffraction by a calculation method (Scherrer's equation) below.

Lc=Kλ/(βcosθ)

K: Scherrer constant (=0.9400)

λ: Wavelength of X-ray beam (=1.54056 Å)

β: Full width at half maximum of peak (radian)

θ: Bragg angle of X-ray diffraction line

Since an active phase of the negative electrode active material a1 is 100 nm or less, it is clear that the active phase is obviously a polycrystal composed of a plurality of grains. When primary particles of silicon are polycrystalline, the grain size is the size of grains contained in the primary particles.

The size of grains forming the active phase is preferably 10 Å to 500 Å and more preferably 150 Å or less. When the grain size is within this range, negative electrode active material particles 33 have increased mechanical strength and are unlikely to be cracked; hence, cycle characteristics are enhanced. When the grain size is too small, the number of electrons not involved in bonds such as dangling bonds increases, which may possibly lead to an increase in irreversible capacity.

### [Preparation of Working Electrode Binder Precursor]

A product obtained by esterifying benzophenone tetracarboxylate dianhydride with 2 equivalents of ethanol and m-phenylenediamine were dissolved in N-methyl-2-pyrrolidone such that the molar ratio of the product to m-phenylenediamine was 1:1, whereby a binder precursor solution was obtained.

### [Preparation of Working Electrode Mix Slurry]

The negative electrode active material a1; a graphite powder, serving as a negative electrode conductive agent, having an average particle size of 3 μm and a BET specific surface area of 12.5 m²/g; and the binder precursor solution were mixed together such that the mass ratio of the negative electrode active material powder to the negative electrode conductive agent powder to a negative electrode active material layer binder was 75:10:15, whereby negative electrode mix slurry was prepared.

Incidentally, for the negative electrode active material layer binder, the mass of a binder obtained by the removal of N-methyl-2-pyrrolidone from the binder precursor solution by drying, a polymerization reaction, and an imidization reaction was used.

### [Preparation of Working Electrode Active Material Layer]

The negative electrode mix slurry prepared as described above was applied to a surface of a negative electrode current collector, made of a copper alloy, having a thickness of 18 μm, a surface roughness of 0.25 μm, and an average peak distance S of 0.85 μm at 25° C. in air, followed by drying at 120° C. in air and then rolling at 25° C. in air. Thereafter, a rectangle with a length of 50 mm and a width of 20 mm was cut out, followed by heat treatment at 300° C. for 10 hours under an argon atmosphere, whereby a mix layer was formed on a surface of the current collector. The amount of a negative electrode active material layer on the negative electrode current collector was 3.0 mg/cm², and the thickness of the mix layer was 28 μm.

### [Preparation of Working Electrode]

A nickel plate serving as a negative electrode current-collecting tab was connected to an end portion of a working electrode prepared as described above, whereby a negative electrode plate was obtained.

### [Preparation of Counter Electrode]

Commercially available metallic Li was used as an active material for a counter electrode. Metallic Li was cut to a length of 80 mm and a width of 50 mm and was used as a counter electrode. A nickel plate serving as a current-collecting tab was connected to an end portion of the counter electrode.

### [Preparation of Nonaqueous Electrolyte Solution]

Under an argon atmosphere, 1 mole per liter of lithium hexafluorophosphate was dissolved in a solvent prepared by mixing ethylene carbonate and methyl ethyl carbonate at a volume ratio of 3:7, whereby a nonaqueous electrolyte solution was prepared.

### [Preparation of Electrode Assembly]

The single positive electrode; the single negative electrode; and two separators composed of a microporous membrane, made of polyethylene, having a thickness of 20 μm, a length of 100 mm, a width of 55 mm, a piercing strength of 340 g, and a porosity of 45% were used. The positive electrode and the negative electrode were arranged to face each other with the separators therebetween and were spirally wound around a columnar winding core such that a positive electrode tab and a negative electrode tab were located on the outermost periphery, whereby a spiral electrode assembly was prepared, followed by obtaining a cylindrical electrode assembly.

The cylindrical electrode assembly and the electrolyte solution prepared as described above were provided in an enclosure made of an aluminium laminate at 25° C. and 1 atm under an argon atmosphere, followed by sealing the laminate, whereby Battery A1 was prepared.

### Example 2

First, a silicon ingot produced by a metallurgical process was crushed, whereby granular silicon with a particle size of 1 mm was prepared. Thereafter, 5 kg of the granular silicon with a particle size of 1 mm and stainless steel bails (20 mm, 30 mm) were charged into a 200 L stainless steel vessel. Next, the stainless steel vessel was subjected to a first mechanical milling treatment in a rotary ball mill so as to have a specific surface area of 10 m/g to 100 m/g as determined by a BET method,

Thereafter, 5 kg of a mixture of the silicon subjected to the first mechanical milling treatment and a Li₂SiO₃ powder (the mixing ratio of Si to Li₂SiO₃ was 70:30 on a mol basis) and stainless steel bails (20 mm, 30 mart) were charged into a 200 L stainless steel vessel and a second mechanical milling treatment was performed for 50 hours in a planetary ball mill. These powders were heat-treated at 800° C. for 4 hours in a 196 MPa inert atmosphere under high-pressure conditions. Thereafter, a sintered product was pulverized and classified in a jet mill such that the median diameter D50 was about 5 μm, whereby a negative electrode active material a2 was obtained.

Battery A2 was prepared in substantially the same manner as that described in Example 1 except that, the negative electrode active material a2 was used instead of the negative electrode active material a1 in the preparation of the negative electrode of Battery A1.

### Example 3

First, a silicon ingot produced by a metallurgical process was crushed, whereby granular silicon with a particle size of 1 mm was prepared. Thereafter, the granular silicon was pulverized and classified in a jet mill such that, the median diameter D50 was about 10 μm.

Thereafter, 50 g of a mixture of a silicon powder pulverized in the jet mill and a Li₂SiO₃ powder (the mixing ratio of Si to Li₂SiO₃ was 84:16 on a mol basis) and stainless steel balls (12 mm) were charged into a 500 mi stainless steel vessel and a mechanical milling treatment was performed for 30 hours in a planetary ball mill. These powders were heat-treated at 600° C. for 10 hours in an inert atmosphere under atmospheric pressure conditions, whereby a negative electrode active material a3 was obtained.

Battery A3 was prepared in substantially the same manner as that described in Example 1 except that the negative electrode active material a3 was used instead of the negative electrode active material a1 in the preparation of the negative electrode of Battery A1.

### Example 4

First, a silicon ingot produced by a metallurgical process was crushed, whereby granular silicon with a particle size of 1 mm was prepared. Thereafter, the granular silicon was pulverized and classified in a jet mill such that the median diameter D50 was about 10 μm.

Thereafter, 50 g of a mixture of a silicon powder pulverized in the jet mill and a Li₄SiO₄ powder (the mixing ratio of Si to Li₄SiO₄ was 75:25 on a mol basis) and stainless steel balls (12 mm) were charged into a 500 ml stainless steel vessel and a mechanical milling treatment was performed for 100 hours in a planetary bail mill. These powders were heat-treated at 300 ° C. for 10 hours in an inert, atmosphere under atmospheric pressure conditions, whereby a negative electrode active material a4 was obtained.

### Example 5

First, a silicon ingot produced by a metallurgical process was crushed, whereby granular silicon with a particle size of 1 mm was prepared. Thereafter, the granular silicon was pulverized and classified in a jet mill such that the median diameter D50 was about 10 μm.

Thereafter, 50 g of a mixture of a silicon powder pulverized in the jet mill and a Li₂SiO₃ powder (the mixing ratio of Si to Li₂SiO₃ was 50:50 on a mol basis) and stainless steel balls (12 mm) were charged into a 500 ml stainless steel vessel and a mechanical milling treatment was performed for 100 hours in a planetary bail mill. These powders were heat-treated at 600° C. for 10 hours in an inert atmosphere under atmospheric pressure conditions, whereby a negative electrode active material a5 was obtained.

Battery A5 was prepared in substantially the same manner as that described in Example 1 except that the negative electrode active material a5 was used instead of the negative electrode active material a1 in the preparation of the negative electrode of Battery A1.

### Example 6

First, a silicon ingot produced by a metallurgical process was crushed, whereby granular silicon with a particle size of 1 mm was prepared. Thereafter, the granular silicon was pulverized and classified in a jet mill such that the median diameter D50 was about 10 μm.

Thereafter, 50 g of a mixture of a silicon powder pulverized in the jet mill, a Li₂SiO₃ powder, and a Ti powder (the mixing ratio of Si to Li₂SiO₃ to Ti was 77:15:8 on a mol basis) and stainless steel balls (12 mm) were charged into a 500 ml stainless steel vessel and a mechanical milling treatment was performed for 30 hours in a planetary ball mill. These powders were heat-treated at 600° C. for 10 hours in an inert atmosphere under atmospheric pressure conditions, whereby a negative electrode active material a6 was obtained.

Battery A6 was prepared in substantially the same manner as that described in Example 1 except that the negative electrode active material a6 was used instead of the negative electrode active material a1 in the preparation of the negative electrode of Battery A1.

### Example 7

First, a silicon ingot produced by a metallurgical process was crushed, whereby granular silicon with a particle size of 1 mm was prepared. Thereafter, the granular silicon was pulverized and classified in a jet mill such that the median diameter D50 was about 10 μm.

Thereafter, 50 g of a mixture of a silicon powder pulverized in the jet mill and a Li₂SiO₃ powder (the mixing ratio of Si to Li₂SiO₃ was 70:30 on a mol basis) and stainless steel balls (12 mm) were charged into a 500 ml stainless steel vessel and a mechanical milling treatment was performed for 30 hours in a planetary ball mill. These powders were heat-treated at 600° C. for 10 hours in an inert atmosphere under atmospheric pressure conditions, whereby a negative electrode active material a7 was obtained.

Battery A7 was prepared in substantially the same manner as that described in Example 1 except that the negative electrode active material a7 was used instead of the negative electrode active material a1 in the preparation of the negative electrode of Battery A1.

### Comparative Example 1

As a comparison to the inventive powder a1, a negative electrode active material b1 was obtained in such a manner that a silicon ingot was crushed, followed by pulverization and classification in a jet mill such that the median diameter D50 was about 5 μm. Battery B1 was prepared in substantially the same manner as that described in Example 1 except that the negative electrode active material b1 was used.

### Comparative Example 2

Into a 20 L stainless steel vessel, 5 kg of granular silicon, mainly containing silicon, having a particle size of 1 mm and stainless steel balls (10 mm, 5 mm) were charged. Next, the stainless steel vessel was set to a mechanical milling machine and was treated for 50 hours.

Thereafter, 500 g of a mixture of silicon subjected to a first mechanical milling treatment and a Li₂SiO₃ powder (the mixing ratio of Si to Li₂SiO₃ was 70:30 on a mol basis) and stainless steel balls (10 mm, 5 mm) were charged into a 20 L stainless steel vessel and a mechanical milling treatment was performed for 50 hours in a planetary ball mill.

These powders were heat-treated at 600° C. for 4 hours in a 196 MPa inert atmosphere under high-pressure conditions. Thereafter, a sintered product was pulverized and classified in a let mill such that the median diameter D50 was about 5 μm, whereby a negative electrode active material b2 was obtained.

Battery B2 was prepared in substantially the same manner as that described in Example 1 except that the negative electrode active material b2 was used.

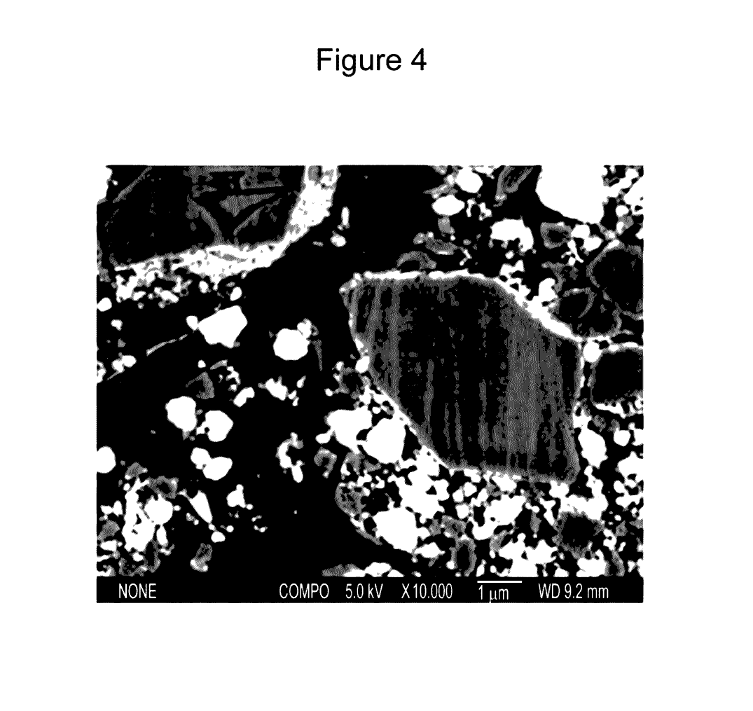

FIG. 4 shows a cross-sectional backscattered electron image of a powder of the negative electrode active material b2. As is clear from FIG. 4, high-contrast white portions (corresponding to active phases made of silicon) and low-contrast gray portions (corresponding to inert phases made of Li₂SiO₃) are independent particles.

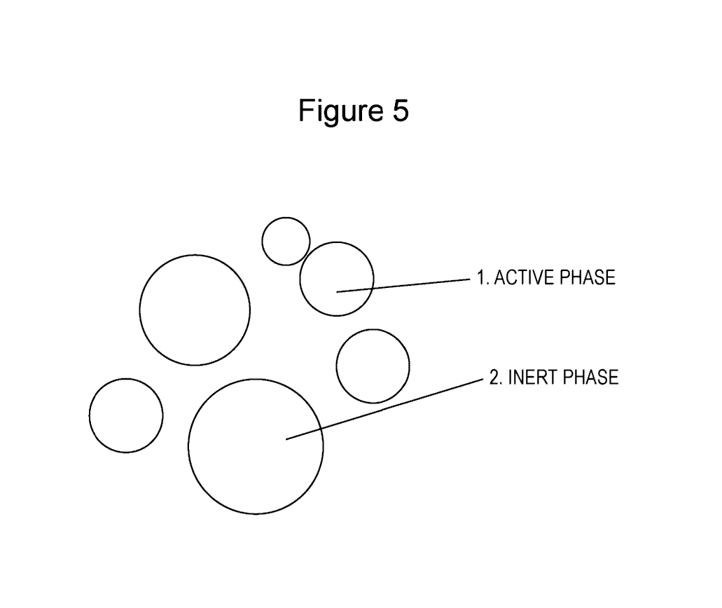

FIG. 5 shows a schematic view of the negative electrode active material b2. FIG. 5 is a schematic view for easily understanding the structure of the negative electrode active material b2 that is inferred from the backscattered electron image in FIG. 4. In this FIG., reference numeral 1 represents active phases made of silicon and reference numeral 2 represents inert phases made of, for example, Li₂SiO₃. The following state is shown: a state that the active phases 1 made of silicon and the inert phases 2 made of Li₂SiO₃ are independent particles.

It is known that the energy generated by a mechanical milling treatment using a rotary ball mill depends on the size of a vessel and the mass of each ball. Furthermore, it is known that, a planetary ball mill can generate higher energy as compared to the rotary ball mill. In the above comparative example, the energy used to hybridize the active phases 1 made of silicon and the inert phases 2 made of Li₂SiO₃ is lower than that used in each example. This probably yields a state that no silicon is covered with an inert phase and no secondary particles are formed.

### (Evaluation of Charge/Discharge Characteristics)

Batteries A1 to A5 of the above examples and batteries B1 and B2 of the above comparative examples were evaluated for charge/discharge characteristics under charge/discharge cycle conditions below.
Charge conditions in first cycle

After constant-current charge was performed at a current of 0.01 I·t for 10 hours, constant-current charge was performed at a current of 0.05 I·t until the potential of a working electrode reached 0 V.
Discharge conditions in first cycle

Constant-current discharge was performed at a current of 0.05 I·t until the voltage of each battery reached 2.0 V.
Charge conditions in second and subsequent cycles

Constant-current charge was performed at a current of 1 I·t until the battery voltage reached 0 V.
Discharge conditions in second and subsequent cycles Constant-current discharge was performed at a current of 1 I·t until the battery voltage reached 2.0 V.

Next, the cycle life was determined by a calculation method below.

The cycle life was determined as the tenth-cycle capacity retention (the value obtained by dividing the tenth-cycle discharge capacity by the first-cycle discharge capacity was defined as the tenth-cycle capacity retention). Results are shown in Table 1 below.

TABLE 1

| | | | | | | Battery data |
|---|---|---|---|---|---|---|
| | | Inert phase | | | Active | Cycle characteristics |
| | Active | Present | | | phase/inert | (10 − cyc discharge |
| | phase | or | | Secondary | phase | capacity)/(1 − cyc |
| | Si | absent | Type | particles | Ratio | discharge capacity) |
| Battery | Si | Present | Li₂SiO₃, FeSi | Present | 70/30 | 0.82 |
| A1 | | | | | | |
| Battery | Si | Present | Li₂Si₂SiO₅, | Present | 70/30 | 0.86 |
| A2 | | | Li₂SiO₃, FeSi | | | |
| Battery | Si | Present | Li₂SiO₃, FeSi | Present | 84/16 | 0.84 |
| A3 | | | | | | |
| Battery | Si | Present | Li₄SiO₄ | Present | 75/25 | 0.76 |
| A4 | | | | | | |
| Battery | Si | Present | Li₂SiO₃, FeSi | Present | 50/50 | 0.84 |
| A5 | | | | | | |
| Battery | Si | Present | Li₂SiO₃, Ti | Present | 77/23 | 0.8 |
| A6 | | | | | | |
| Battery | Si | Absent | — | Absent | — | 0.66 |
| B1 | | | | | | |
| Battery | Si | Present | Li₂SiO₃ | Absent | 70/30 | 0.48 |
| B2 | | | | | | |

As is clear from the results shown in Table 1, batteries A1 to A6 of Examples 1 to 6 have enhanced cycle characteristics as compared to Battery B1 of Comparative Example 1 that lacks secondary particles and that is not covered with an inert phase made of a silicon compound with a silicon oxidation number higher than that of silicon, a metal-silicon alloy, or metal.

It is clear that batteries A1 to A6 of Examples 1 to 6 have enhanced cycle characteristics as compared to Battery B2 of Comparative Example 2 that simply mixes Li₂SiO₃ and that lacks secondary particles.

Preparation conditions for hybridizing an active phase and an inert phase, the crystallite size of an active phase that is determined from results of X-ray diffraction, and the cycle life are shown in Table 2 below.

TABLE 2

| | | | | | | | | | | Battery data |
|---|---|---|---|---|---|---|---|---|---|---|
| | | | | | | | | | | Cycle |
| | | | | | | | | | | characteristics |
| | | | | Active | | | | | | (10 − cyc |
| | Preparation conditions | | | phase | | Inert phase | | | Active | discharge |
| | | | Heat- | | crystallite | Present | | | phase/inert | capacity)/(1 − |
| | | Hybridization | treatment | | size | or | | Secondary | phase | cyc discharge |
| | Hybridizer | time | temperature | Si | (Å) | absent | Type | particles | Ratio | capacity) |
| Battery | Planetary | 50 h | 196 Mpa | Si | 120 | Present | Li₂SiO₃, | Present | 70/30 | 0.82 |
| A1 | ball mill | | 600° C. | | | | FeSi | | | |
| Battery | Planetary | 30 h | Atmospheric | Si | 196 | Present | Li₂SiO₃, | Present | 70/30 | 0.69 |
| A7 | ball mill | | pressure | | | | FeSi | | | |
| | | | 600° C. | | | | | | | |

| | | | | | | | | |
|---|---|---|---|---|---|---|---|---|
| Battery | Not treated | Si | 891 | Absent | — | Absent | — | 0.66 |
| B1 | | | | | | | | |

As is clear from results shown in Table 2, Battery A1 of Example 1 and Battery A7 of Example 7 have enhanced cycle characteristics as compared to Battery B1 of Comparative Example 1 that has a large crystallite size. Furthermore, Battery A1 of Example 1 that has a small crystallite size has enhanced cycle characteristics as compared to and Battery A7 of Example 7 that has a large crystallite size.

From the above, it is clear that excellent cycle characteristics are exhibited due to secondary particles composed of a plurality of aggregated primary particles containing silicon and the fact that the surface of each of the secondary particles is covered with an inert phase made of a silicon compound with a silicon oxidation number higher than that of silicon, a metal-silicon alloy, or metal.

### INDUSTRIAL APPLICABILITY

The present invention is applicable to, for example, power supplies for driving mobile data terminals such as mobile phones, notebook personal computers, and PDAs and particularly applications requiring high energy density.

### REFERENCE SIGNS LIST

1 Active phases

2 Inert phases

1. A negative electrode active material for nonaqueous electrolyte secondary batteries containing at least silicon, wherein at least one portion of the surface of each of primary particle containing silicon is covered with an inert phase made of a silicon compound with a silicon oxidation number higher than that of the silicon, a metal-silicon alloy, or metal.

2. The negative electrode active material for nonaqueous electrolyte secondary batteries according to claim 1, wherein the silicon compound is a silicon oxide or a lithium silicate.

3. The negative electrode active material for nonaqueous electrolyte secondary batteries according to claim 1, wherein the primary particles containing silicon form secondary particles.

4. The negative electrode active material for nonaqueous electrolyte secondary batteries according to claim 1, wherein the ratio of the secondary particle composed of the aggregated primary particles containing silicon to the inert phase made of the silicon compound with a silicon oxidation number higher than that of the silicon, the metal-silicon alloy, or the metal ranges from 50:50 to 85:15.

5. The negative electrode active material for nonaqueous electrolyte secondary batteries according to claim 1, wherein the crystallite size of the silicon is 500 Å or less.

6. The negative electrode active material for nonaqueous electrolyte secondary batteries according to claim 1, wherein the silicon compound with a silica oxidation number higher than that of the silicon is Li₂Si₂O₅, Li₂SiO₃, or Li₄SiO₄.

7. The negative electrode active material for nonaqueous electrolyte secondary batteries according to claim 1, wherein the metal is Ti.

8. The negative electrode active material for nonaqueous electrolyte secondary batteries according to claim 1, wherein the metal-silicon alloy is FeSi.
